(19) United States
(12) Patent Application Publication
(10) Pub. No.: US 2025/0283372 A1
(43) Pub. Date: Sep. 11, 2025

(54) SPACER APPLICATOR AND SPACER APPLYING METHOD FOR INSULATING GLASS

(71) Applicant: Panjin Xinghua Machinery Manufacturing Co., Ltd., Panjin City (CN)

(72) Inventors: Wengang MO, Panjin City (CN); Yuechao ZHAO, Panjin City (CN); Weidong RONG, Panjin City (CN)

(21) Appl. No.: 19/031,520

(22) Filed: Jan. 18, 2025

(30) Foreign Application Priority Data
Mar. 7, 2024 (CN) 2024102590295

(51) Int. Cl. E06B 3/673; E06B 3/663

(52) U.S. Cl. CPC E06B 3/6733; E06B 3/66304; E06B 3/67365

(57) ABSTRACT

The present invention discloses a spacer applicator and a spacer applying method for insulating glass, and belongs to the technical field of insulating glass pulling belt bonding. The present invention aims to solve the problem that the conventional spacer applicator for insulating glass needs to position a starting point of a spacer twice after completing the spacer applying once, and the warm edge spacer after the spacer applying is also prone to twisting, deformation, and large corner curvature. The present invention includes a glass carrying frame, a motion mechanism for driving glass to move horizontally being mounted on the glass carrying frame, a fixing column being connected to a surface on one side of the glass carrying frame on which the motion mechanism is mounted, a head being slidably connected to the fixing column, a spacer feeding mechanism being provided on an outer side of the glass carrying frame.

### CROSS REFERENCE TO RELATED APPLICATIONS

The present application claims the priority of Chinese patent application No. 2024102590295, filed on Mar. 7, 2024, and contents of which are incorporated herein by reference.

### BACKGROUND OF THE INVENTION

### Field of the Invention

The present invention belongs to the technical field of insulating glass spacer applying, and in particular, relates to a spacer applicator and a spacer applying method for insulating glass.

### Description of Related Art

Insulating glass is a glass product in which two or more pieces of glass are evenly spaced apart by effective support and bonded and sealed around, so that a dry gas space is formed between glass layers, and is a new type of building material that has good heat insulation and sound insulation, is beautiful and practical, and can reduce a weight of a building.

During a manufacturing process of the insulating glass, the insulating glass needs to undergo a spacer applying process, that is, a warm edge spacer is bonded and sealed to an edge of two layers of glass to achieve an effect of sealing a space between the two layers of glass.

In a traditional spacer applicator, the warm edge spacer is bonded to the edge of the glass by driving the glass to move in a horizontal direction and then cooperating with rotation and up-down direction movement of a head.

However, cutters on the traditional head are all provided on a tail end of the head, before the spacer applying is completed, the spacer needs to be cut in advance, and then the last step of the spacer applying is completed, and when the spacer applying for the next insulating glass is continuously performed, a starting point of the spacer needs to be positioned twice, which not only reduces a spacer applying speed, but also easily causes the starting point position of the spacer to be not fixed, resulting in a problem of poor sealing; at the same time, when the spacer is bonded to a corner, a sealing direction of the warm edge spacer is usually changed by rotating the head by 90 degrees, however, since the warm edge spacer is mostly made of butyl rubber material and has certain elasticity, when the head drives the warm edge spacer to rotate, it is easy to cause the spacer to tilt, and under action of an elastic force of the warm edge spacer, the warm edge spacer is also prone to twisting, deformation, and large corner curvature.

### SUMMARY OF THE INVENTION

In order to solve the above problems, that is, the conventional spacer applicator for insulating glass needs to position a starting point of a spacer twice after completing the spacer applying once, and the warm edge spacer after the spacer applying is also prone to twisting, deformation, and large corner curvature. A spacer applicator for insulating glass according to the present invention includes a glass carrying frame, a motion mechanism for driving glass to move horizontally being mounted on the glass carrying frame, a fixing column being connected to a surface on one side of the glass carrying frame on which the motion mechanism is mounted, a head being slidably connected to the fixing column, a spacer feeding mechanism being provided on an outer side of the glass carrying frame. A group of guide wheels, a driving wheel, a pressing mechanism and a cutter are mounted on one end of the head close to the glass carrying frame, the pressing mechanism is provided on a side of the driving wheel away from the group of guide wheels, and the cutter is provided on a side of the pressing mechanism away from the driving wheel.

The present invention is further configured as follows:
the pressing mechanism includes a cylinder, an output end of the cylinder is connected with a pressing plate, and a fixing plate is provided below the pressing plate.

The present invention is further configured as follows:
the spacer applying spacer applicator for insulating glass further includes: a base, in which the head is rotatably connected to the base, and a first driving device that drives the head to rotate is mounted on the base,
a mounting plate is slidably connected to the fixing column, and a second driving device that drives the mounting plate to move along a fixing direction is mounted on the mounting plate,
the base is slidably connected to the mounting plate, and a third driving device that drives the base to slide along a direction perpendicular to the fixing column is further mounted on the base.

The present invention is further configured as follows:
the motion mechanism includes two synchronous belts, the two synchronous belts are symmetrically provided with respect to the fixing column, the synchronous belts are provided perpendicular to the fixing column, and a fourth driving device that drives the synchronous belts to rotate is mounted on the glass carrying frame.

The present invention is further configured as follows:
the motion mechanism further includes a glass pulling belt, the glass pulling belt is provided on a side of the synchronous belts away from the fixing column, the glass pulling belt is provided parallel to the synchronous belt, a suction cup is mounted on the glass pulling belt, and a fifth driving device that drives the glass pulling belt to rotate is further mounted on the glass carrying frame.

The present invention is further configured as follows:
an auxiliary support frame is slidably connected to an upright column of the glass carrying frame, the auxiliary support frame is provided parallel to the synchronous belt, a plurality of pulleys are rotatably connected to the auxiliary support frame, and the plurality of pulleys are disposed along a length direction of the auxiliary support frame.

The present invention is further configured as follows:
the glass carrying frame is further provided with a plurality of wide toothed belts, the wide toothed belts are provided perpendicular to the auxiliary support frame, the auxiliary support frame is fixedly connected to the plurality of wide toothed belts, and a sixth driving device that drives the wide toothed belts to rotate is mounted on the glass carrying frame.

The present invention is further configured as follows:
a row of pulling wheels are further mounted on the glass carrying frame, and the pulling wheels are provided between the two synchronous belts.

The present invention also provides a spacer applying method for insulating glass, the spacer applicator for insulating glass according to any one of the above being used to perform spacer applying on insulating glass, the method including:
S1: placing glass on the synchronous belts, and driving the glass until one top corner of the glass is aligned with a warm edge spacer;
S2: driving the cylinder to lift up such that the warm edge spacer is no longer clamped;
S3: driving the synchronous belts and the glass pulling belt to drive the glass to move horizontally to the next top corner to be bonded with the warm edge spacer;
S4: driving the cylinder to press down to compress the warm edge spacer, and then driving the head to rotate forward by 90 degrees+(0 degrees to 45 degrees), and then to rotate backward by 0 degrees to 45 degrees;
S5: driving the base to drive the head to move up and down to the next top corner to be bonded with the warm edge spacer;
S6: driving the cylinder to press down to compress the warm edge spacer, and then driving the head to rotate forward by 90 degrees+ (0 degrees to 45 degrees), and then to rotate backward by 0 degrees to 45 degrees;
S7: driving the synchronous belts and the glass pulling belt to drive the glass to move horizontally to the next top corner to be bonded with the warm edge spacer;
S8: driving the cylinder to press down to compress the warm edge spacer, and then driving the head to rotate forward by 90 degrees+ (0 degrees to 45 degrees), and then to rotate backward by 0 degrees to 45 degrees;
S9: driving the base to drive the head to move up and down to the next top corner to be bonded with the warm edge spacer;
S10: driving the cylinder to press down to compress the warm edge spacer, and then using the cutter to cut off a bonding end of the warm edge spacer.

The present invention has the following beneficial effects.
1. By providing the cutter on the side of the pressing mechanism away from the driving wheel, the warm edge spacer can be cut off after the spacer applying is completed, and a pressing effect on the warm edge spacer can be achieved by cooperating with pressing of the pressing mechanism, and then after the cutting, a starting position of the warm edge spacer can be always kept fixed, so that secondary positioning is not required, and continuous automatic spacer feeding is achieved, which greatly improves a spacer applying speed and a sealing effect; at the same time, during a cornering process, through the pressing of the pressing mechanism, the position of the warm edge spacer can be kept fixed, thereby avoiding the problems of warping, twisting, deformation, and large corner curvature of the warm edge spacer caused by internal stress generated by the warm edge spacer.
2. Through cooperation of the glass pulling belt and the suction cup, movement of the glass on the glass carrying frame can be more stable.
3. By slidably connecting the auxiliary support frame with the upright column of the glass carrying frame, a purpose of adjusting a height of the auxiliary support frame can be achieved, so that the device can satisfy a function of performing spacer applying on the glass of different specifications and sizes, and at the same time, the row of pulling wheels is provided between the two synchronous belts, which can not only avoid interference between the warm edge spacer and the synchronous belts, but also achieve a supporting effect on small-sized glass, thereby avoiding a phenomenon that the small-sized glass is dumped due to lack of support when passing between the two synchronous belts.
4. During the cornering process, the warm edge spacer is rotated to an interference angle greater than 90 degrees, so that the warm edge spacer can be clamped closer to 90 degrees, thereby avoiding the problem of large corner curvature.

### BRIEF DESCRIPTION OF THE DRAWINGS

FIG. 1 shows a schematic structural diagram of the present invention.

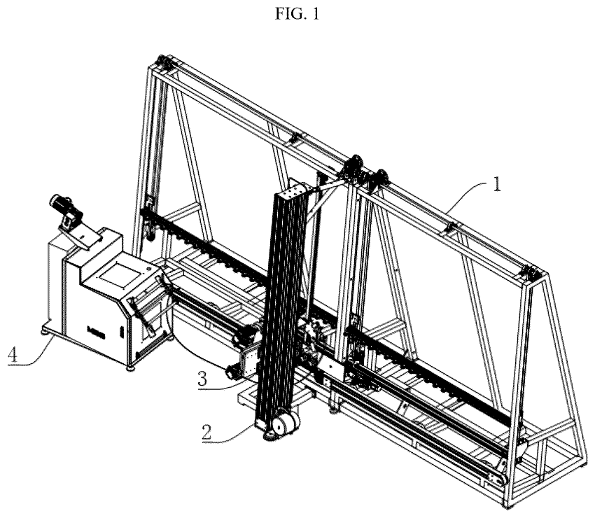

FIG. 2 shows a schematic structural diagram of a glass carrying frame.

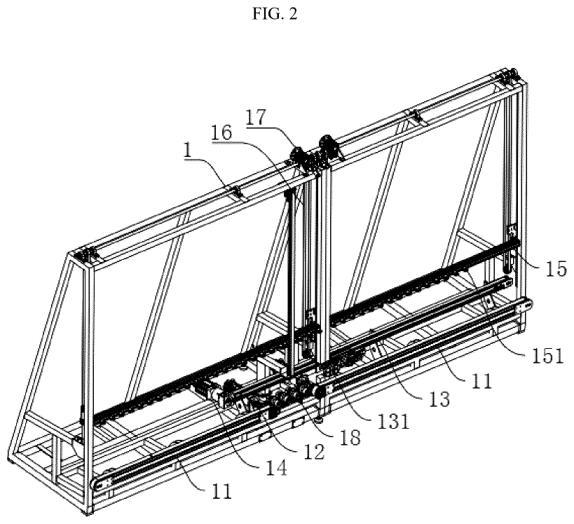

FIG. 3 is a schematic structural diagram of a head.

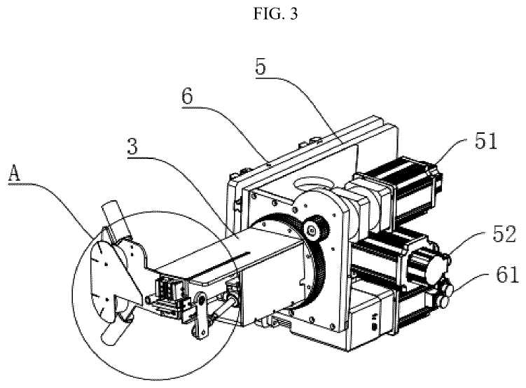

FIG. 4 shows a partial enlarged view at A.

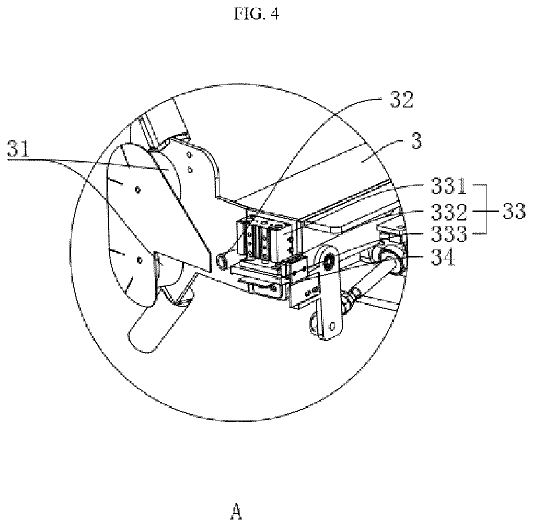

FIG. 5 is a schematic structural diagram.

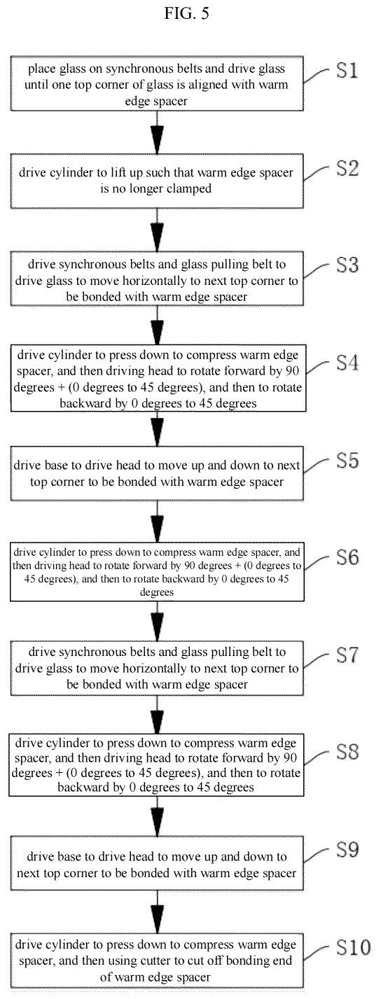

### REFERENCE SIGNS LIST

1: glass carrying frame;
11: synchronous belt;
12: fourth driving device;
13: glass pulling belt;
131: suction cup;
14: fifth driving device;
15: auxiliary support frame;
151: pulley;
16: wide toothed belt;
17: sixth driving device;
18: pulling wheel;
2: fixing column;
3: head;
31: guide wheel;
32: driving wheel;
33: pressing mechanism;
331: cylinder;
332: pressing plate;
333: fixing plate;
34: cutter;
4: spacer feeding mechanism;
5: base;
51: first driving device;
52: third driving device;
6: mounting plate;
61: second driving device

### DETAILED DESCRIPTION OF THE INVENTION

Preferred embodiments of the present invention are described below with reference to the accompanying drawings.

Those skilled in the art should understand that these embodiments are merely used to explain the technical principles of the present invention, and are not intended to limit the protection scope of the present invention.

### Embodiment 1

The present embodiment provides a spacer applicator for insulating glass, including a glass carrying frame 1. One side of the glass carrying frame 1 that supports glass is tilted so that the glass can be tilted to prevent the glass from falling down when the glass is vertical.

A motion mechanism that drives the glass to move horizontally is mounted on the glass carrying frame 1, a fixing column 2 is further connected to a side surface of the glass carrying frame 1 on which the motion mechanism is mounted, the fixing column 2 is provided in parallel with the glass on the glass carrying frame 1, a top end of the fixing column 2 is fixedly connected to the glass carrying frame 1 through a connecting rod, and a bottom end of the fixing column 2 is fixedly connected to the glass carrying frame 1 through a front bracket.

A head 3 is slidably connected to the fixing column 2, a spacer feeding mechanism 4 is further provided on an outer side of the glass carrying frame 1, the spacer feeding mechanism 4 includes a large shaft of spacer, and a warm edge spacer for bonding is wound on the large shaft of spacer.

A group of guide wheels 31, a driving wheel 32, a pressing mechanism 33 and a cutter 34 are mounted on one end of the head 3 close to the glass carrying frame 1, the group of guide wheels 31 includes two guide wheels 31, the two guide wheels 31 are provided up and down, and the warm edge spacer passes between the two guide wheels 31.

The pressing mechanism 33 is provided on a side of the driving wheel 32 away from the group of guide wheels 31, and the cutter 34 is provided on a side of the pressing mechanism 33 away from the driving wheel 32, so that after spacer applying on one piece of glass is finished, the warm edge spacer is pressed by the pressing mechanism 33 to keep the warm edge spacer at a fixed position, and at this time, the warm edge spacer is cut off by the cutter 34, so that when the spacer applying on the next piece of glass is performed, secondary positioning is not required.

The pressing mechanism 33 includes a cylinder 331, the cylinder 331 is provided vertically, an output end of the cylinder 331 is provided downward and is welded with a pressing plate 332, a fixing plate 333 is provided below the pressing plate 332, the fixing plate 333 is welded with the head 3, the pressing plate 332 is provided in parallel with the fixing plate 333, and a purpose of adjusting a distance between the pressing plate 332 and the fixing plate 333 can be achieved through the cylinder 331, thereby achieving pressing and loosening of the warm edge spacer.

The spacer applicator for insulating glass further includes a base 5, the head 3 is rotatably connected to the base 5, and a first driving device 51 is connected to a side surface of the base 5 away from the head 3 through bolts, and is selected as a motor, and an output end of the first driving device 51 is connected to the base 5 through a gear set, thereby achieving a purpose of driving the head 3 to rotate.

A mounting plate 6 is slidably connected to the fixing column 2, a second driving device 61 is connected to the mounting plate 6 through bolts, and is selected as a motor, an output end of the second driving device 61 is connected to the fixing column 2 through a gear rack, thereby achieving a purpose of driving the mounting plate 6 to slide along a direction of the fixing column 2, and a sliding rail and a sliding block are further mounted between the fixing column 2 and the mounting plate 6 to achieve a function of guiding movement of the mounting plate 6.

The base 5 is slidably connected to the mounting plate 6, a sliding direction of the base 5 is perpendicular to the fixing column 2, a third driving device 52 is connected to the base 5 through bolts, and an output end of the third driving device 52 is connected to the mounting plate 6 through a gear rack, thereby achieving a purpose of driving the base 5 to slide relative to the mounting plate 6.

The first driving device 51 can be used to drive the head 3 to rotate, so that a purpose of changing a direction of the spacer applying can be achieved when the spacer applying reaches a corner of the glass, and the second driving device 61 can be used to drive the head 3 to move up and down.

When the spacer applying is completed, the third driving device 52 can be used to drive the head 3 to move away from the glass, and then the glass is conveyed out to prevent the head 3 from interfering with the glass.

The motion mechanism includes two synchronous belts 11, the synchronous belts 11 are mounted on the glass carrying frame 1, the two synchronous belts 11 are symmetrically provided with respect to the fixing column 2, and are provided perpendicular to the fixing column 2, the two synchronous belts 11 are provided at equal distances, a fourth driving device 12 is connected to the glass carrying frame 1 by bolts, and is selected as a motor, an output end of the fourth driving device 12 is rotatably connected to the synchronous belts 11 through a coupling to achieve a purpose of driving the synchronous belts 11 to rotate. During use, the glass is placed on the synchronous belts 11, and rotation of the synchronous belts 11 can achieve a purpose of driving the glass to move along a horizontal direction.

The motion mechanism further includes a glass pulling belt 13, the glass pulling belt 13 is also mounted on the glass carrying frame 1, is provided on a side of the synchronous belts 11 away from the fixing column 2, and is provided parallel to the synchronous belts 11, the glass pulling belt 13 is fixedly connected with a suction cup 131, when the glass is placed on the synchronous belts 11, the suction cup 131 can suck a side surface of the glass away from the fixing column 2, during use, the glass pulling belt 13 and the two synchronous belts 11 operate synchronously, and through cooperation of the suction cup 131 and the glass pulling belt 13, the glass can move more stably on the glass carrying frame 1.

The glass carrying frame 1 is also connected to a fifth driving device 5 14 by bolts, the fifth driving device 14 is selected as a motor, and an output end of the fifth driving device 14 is coaxially connected to a rotating shaft of the glass pulling belt 13 through a coupling to drive the glass pulling belt 13 to rotate.

An auxiliary support frame 15 is slidably connected to an upright column of the glass carrying frame 1, the auxiliary support frame 15 is provided parallel to the synchronous belts 11, the auxiliary support frame 15 is provided above the synchronous belts 11, a plurality of pulleys 151 are rotatably connected to a side surface of the auxiliary support frame 15 close to the glass, the plurality of pulleys 151 are disposed in a row along a length direction of the auxiliary support frame 15, when the glass is placed on the synchronous belts 11 for movement, the pulleys 151 can support the glass, and at the same time, a contact area between the pulleys 151 and the glass is small, thereby reducing frictional resistance during the movement of the glass.

Four wide toothed belts 16 are further mounted on the glass carrying frame 1, the wide toothed belts 16 are provided perpendicular to the auxiliary support frames 15, the auxiliary support frame 15 is fixedly connected to the four wide toothed belts 16 by bolts, the top of the glass carrying frame 1 is connected to a sixth driving device 17 by bolts, the sixth driving device 17 is selected as a motor, and the sixth driving device 17 is coaxially connected to rotating shafts of the four wide toothed belts 16 through a long axis to drive the four wide toothed belts 16 to rotate at the same time, and then rotation of the wide toothed belts 16 can drive the auxiliary support frames 15 to move up and down along a direction of the wide toothed belts 16.

By adjusting a height of the auxiliary support frame 15, it is possible to perform the spacer applying on glass of different specifications and sizes, thereby making the device more adaptable.

Four pulling wheels 18 is further mounted on the glass carrying frame 1, the four pulling wheels 18 are provided in a row along a direction of the synchronous belts 11, and are provided between the two synchronous belts 11, which can not only avoid interference between the warm edge spacer and the synchronous belts 11, but also achieve a supporting effect on small-sized glass, thereby avoiding a phenomenon that the small-sized glass is dumped due to lack of support when passing between the two synchronous belts 11.

In summary, in the present embodiment, by providing the cutter 34 on the side of the pressing mechanism 33 away from the driving wheel 32, the warm edge spacer can be cut off after the spacer applying is completed, and a pressing effect on the warm edge spacer can be achieved by cooperating with pressing of the pressing mechanism 33, and then after the cutting, a starting position of the warm edge spacer can be always kept fixed, so that secondary positioning is not required, and continuous automatic spacer feeding is achieved, which greatly improves a spacer applying speed and a sealing effect; at the same time, during a cornering process, through the pressing of the pressing mechanism 33, the position of the warm edge spacer can be kept fixed, thereby avoiding the problems of warping, twisting, deformation, and large corner curvature of the warm edge spacer caused by internal stress generated by the warm edge spacer.

Through cooperation of the glass pulling belt 13 and the suction cup 131, the glass can move more stably on the glass carrying frame 1.

By slidably connecting the auxiliary support frame 15 with the upright column of the glass carrying frame 1, a purpose of adjusting a height of the auxiliary support frame 15 can be achieved, so that the device can satisfy a function of performing spacer applying on the glass of different specifications and sizes, and at the same time, the row of pulling wheels 18 is provided between the two synchronous belts 11, which can not only avoid interference between the warm edge spacer and the synchronous belts 11, but also achieve a supporting effect on small-sized glass, thereby avoiding a phenomenon that the small-sized glass is dumped due to lack of support when passing between the two synchronous belts 11.

### Embodiment 2

The present embodiment provides a method for performing spacer applying on insulating glass by using the spacer applicator for insulating glass in Embodiment 1, and the method includes:
S1: placing glass on the synchronous belts 11, and driving the glass until one top corner of the glass is aligned with a warm edge spacer;
S2: driving the cylinder 331 to lift up such that the warm edge spacer is no longer clamped;
S3: driving the synchronous belts 11 and the glass pulling belt 13 to drive the glass to move horizontally to the next top corner to be bonded with the warm edge spacer;
S4: driving the cylinder 331 to press down to compress the warm edge spacer, and then driving the head 3 to rotate forward by 90 degrees+ (0 degrees to 45 degrees), and then to rotate backward by 0 degrees to 45 degrees;
S5: driving the base 5 to drive the head 3 to move up and down to the next top corner to be bonded with the warm edge spacer;
S6: driving the cylinder 331 to press down to compress the warm edge spacer, and then driving the head 3 to rotate forward by 90 degrees+ (0 degrees to 45 degrees), and then to rotate backward by 0 degrees to 45 degrees;
S7: driving the synchronous belts 11 and the glass pulling belt 13 to drive the glass to move horizontally to the next top corner to be bonded with the warm edge spacer;
S8: driving the cylinder 331 to press down to compress the warm edge spacer, and then driving the head 3 to rotate forward by 90 degrees+ (0 degrees to 45 degrees), and then to rotate backward by 0 degrees to 45 degrees;
S9: driving the base 5 to drive the head 3 to move up and down to the next top corner to be bonded with the warm edge spacer;
S10: driving the cylinder 331 to press down to compress the warm edge spacer, and then using the cutter 34 to cut off a bonging end of the warm edge spacer.

In summary, in present embodiment, during the cornering process, the warm edge spacer is rotated to an interference angle greater than 90 degrees, so that the warm edge spacer can be clamped closer to 90 degrees, thereby avoiding the problem of large corner curvature.

Although the present invention has been described with reference to preferred embodiments, various modifications may be made thereto and parts thereof may be replaced by equivalents without departing from the scope of the present invention. In particular, the various technical features mentioned in the various embodiments may be combined in any manner as long as there is no structural conflict.

The present invention is not limited to the specific embodiments disclosed herein, but includes all technical solutions falling within the scope of the claims.

In the description of the present invention, the terms “center”, “upper”, “lower”, “left”, “right”, “vertical”, “horizontal”, “inner”, “outer”, and the like indicating directions or positional relationships are based on the directions or positional relationships shown in the drawings. This is merely for the convenience of description and does not indicate or imply that the device or element must have a specific orientation, be constructed and operated in a specific orientation. Therefore, it should not be understood as a limitation on the present invention.

In addition, the terms “first”, “second”, and “third” are used for descriptive purposes only and are not to be construed as indicating or implying relative importance.

In addition, in the description of the present invention, it should be noted that, the terms “mount”, “couple”, and “connect” should be understood broadly unless otherwise clearly specified or defined, for example, the terms may refer to fixed connection, detachable connection, or integral connection; may refer to mechanical connection or electrical connection; may refer to direct connection or indirect connection through an intermediate medium, and may also refer to internal connection of two components.

The specific meanings of the above terms in the present invention may be understood in specific circumstances by those skilled in the art.

The term “comprise” or any other similar term is intended to cover a non-exclusive inclusion, so that a process, article, or apparatus/device that includes a list of elements includes not only those elements but also other elements not expressly listed, or further contains inherent elements of the process, article, or apparatus/device.

So far, the technical solutions of the present invention have been described in conjunction with the preferred embodiments shown in the drawings. However, those skilled in the art can easily understand that the protection scope of the present invention is obviously not limited to these specific embodiments.

Those skilled in the art can make equivalent changes or substitutions to related technical features without departing from the principle of the present invention, and the technical solutions after these changes or substitutions shall fall within the protection scope of the present invention.

The present invention discloses a spacer applicator and a spacer applying method for insulating glass, and belongs to the technical field of insulating glass pulling belt bonding. The present invention aims to solve the problem that the conventional spacer applicator for insulating glass needs to position a starting point of a spacer twice after completing the spacer applying once, and the warm edge spacer after the spacer applying is also prone to twisting, deformation, and large corner curvature. The present invention includes a glass carrying frame, a motion mechanism for driving glass to move horizontally being mounted on the glass carrying frame, a fixing column being connected to a surface on one side of the glass carrying frame on which the motion mechanism is mounted, a head being slidably connected to the fixing column, a spacer feeding mechanism being provided on an outer side of the glass carrying frame. A group of guide wheels, a driving wheel, a pressing mechanism and a cutter are mounted on one end of the head close to the glass carrying frame, the pressing mechanism is provided on a side of the driving wheel away from the group of guide wheels, and the cutter is provided on a side of the pressing mechanism away from the driving wheel.

What is claimed is:

1. A spacer applicator for insulating glass, comprising:
a glass carrying frame (1), a motion mechanism for driving glass to move horizontally being mounted on the glass carrying frame (1), a fixing column (2) being connected to a surface on one side of the glass carrying frame (1) on which the motion mechanism is mounted, a head (3) being slidably connected to the fixing column (2), a spacer feeding mechanism (4) being provided on an outer side of the glass carrying frame (1), wherein
a group of guide wheels (31), a driving wheel (32), a pressing mechanism (33) and a cutter (34) are mounted on one end of the head (3) close to the glass carrying frame (1), the pressing mechanism (33) is provided on a side of the driving wheel (32) away from the group of guide wheels (31), and the cutter (34) is provided on a side of the pressing mechanism (33) away from the driving wheel (32).

2. The spacer applicator for insulating glass according to claim 1, wherein
the pressing mechanism (33) includes a cylinder (331), an output end of the cylinder (331) is connected with a pressing plate (332), and a fixing plate (333) is provided below the pressing plate (332).

3. The spacer applicator for insulating glass according to claim 1, further comprising:
a base (5), wherein the head (3) is rotatably connected to the base (5), and a first driving device (51) that drives the head (3) to rotate is mounted on the base (5),
a mounting plate (6) is slidably connected to the fixing column (2), and a second driving device (61) that drives the mounting plate (6) to move along a fixing direction is mounted on the mounting plate (6),
the base (5) is slidably connected to the mounting plate (6) and a third driving device (52) that drives the base (5) to slide along a direction perpendicular to the fixing column (2) is further mounted on the base (5).

4. The spacer applicator for insulating glass according to claim 1, wherein
the motion mechanism includes two synchronous belts (11), the two synchronous belts (11) are symmetrically provided with respect to the fixing column (2), the synchronous belts (11) are provided perpendicular to the fixing column (2), and a fourth driving device (12) that drives the synchronous belts (11) to rotate is mounted on the glass carrying frame (1).

5. The spacer applicator for insulating glass according to claim 4, wherein
the motion mechanism further includes a glass pulling belt (13), the glass pulling belt (13) is provided on a side of the synchronous belts (11) away from the fixing column (2), the glass pulling belt (13) is provided parallel to the synchronous belt (11), a suction cup (131) is mounted on the glass pulling belt (13), and a fifth driving device (14) that drives the glass pulling belt (13) to rotate is further mounted on the glass carrying frame (1).

6. The spacer applicator for insulating glass according to claim 5, wherein
an auxiliary support frame (15) is slidably connected to an upright column of the glass carrying frame (1), the auxiliary support frame (15) is provided parallel to the synchronous belt (11), a plurality of pulleys (151) are rotatably connected to the auxiliary support frame (15), and the plurality of pulleys (151) are disposed along a length direction of the auxiliary support frame (15).

7. The spacer applicator for insulating glass according to claim 6, wherein
a plurality of wide toothed belts (16) is further mounted on the glass carrying frame (1), the wide toothed belts (16) are provided perpendicular to the auxiliary support frame (15), the auxiliary support frame (15) is fixedly connected to the plurality of wide toothed belts (16), and a sixth driving device (17) that drives the wide toothed belts (16) to rotate is mounted on the glass carrying frame (1).

8. The spacer applicator for insulating glass according to claim 4, wherein
a row of pulling wheels (18) are further mounted on the glass carrying frame (1), and the pulling wheels (18) are provided between the two synchronous belts (11).

9. A spacer applying method for insulating glass,
the spacer applicator for insulating glass according to claim 1 being used to perform spacer applying on insulating glass, the method comprising:
S1: placing glass on the synchronous belts (11) and driving the glass until one top corner of the glass is aligned with a warm edge spacer;
S2: driving the cylinder (331) to lift up such that the warm edge spacer is no longer clamped;
S3: driving the synchronous belts (11) and the glass pulling belt (13) to drive the glass to move horizontally to the next top corner to be bonded with the warm edge spacer;
S4: driving the cylinder (331) to press down to compress the warm edge spacer, and then driving the head (3) to rotate forward by 90 degrees+(0 degrees to 45 degrees), and then to rotate backward by 0 degrees to 45 degrees;
S5: driving the base (5) to drive the head (3) to move up and down to the next top corner to be bonded with the warm edge spacer;
S6: driving the cylinder (331) to press down to compress the warm edge spacer, and then driving the head (3) to rotate forward by 90 degrees+(0 degrees to 45 degrees), and then to rotate backward by 0 degrees to 45 degrees;
S7: driving the synchronous belts (11) and the glass pulling belt (13) to drive the glass to move horizontally to the next top corner and to be bonded with the warm edge spacer;
S8: driving the cylinder (331) to press down to compress the warm edge spacer, and then driving the head (3) to rotate forward by 90 degrees+(0 degrees to 45 degrees), and then to rotate backward by 0 degrees to 45 degrees;
S9: driving the base (5) to drive the head (3) to move up and down to the next top corner to be bonded with the warm edge spacer;
S10: driving the cylinder (331) to press down to compress the warm edge spacer, and then using the cutter (34) to cut off a bonding end of the warm edge spacer.
